(19) United States
(12) Patent Application Publication
(10) Pub. No.: US 2025/0368480 A1
(43) Pub. Date: Dec. 4, 2025

(54) STEP POSITION DETECTION APPARATUS

(71) Applicant: OPTOWL Co., Ltd., Iwate (JP)

(72) Inventor: Ren SAITO, Iwate (JP)

(21) Appl. No.: 19/216,954

(22) Filed: May 23, 2025

(30) Foreign Application Priority Data
May 29, 2024 (JP) 2024-086877

(51) Int. Cl. B66F 9/075

(52) U.S. Cl. CPC B66F 9/0755

(57) ABSTRACT

A step position detection apparatus includes a processor; and a memory that includes instructions, which when executed, cause the processor to execute: acquiring, by an imaging device, a condition including at least a road surface around a work machine, as point group information; estimating an area where unevenness of the road surface does not exceed a predetermined height, as a flat road based on the acquired point group information including height information; and estimating an extended part of the road surface hidden by a step, among a first flat road where the work machine exists and a second flat road located at a lower position than the first flat road included in the estimated flat road.

### CROSS-REFERENCE TO RELATED APPLICATION

The present application is based on and claims priority under 35 U.S.C. § 119 to Japanese Patent Application No. 2024-086877, filed on May 29, 2024, the contents of which are incorporated herein by reference in their entirety.

### BACKGROUND OF THE INVENTION

### 1. Field of the Invention

The present invention relates to a step position detection apparatus.

### 2. Description of the Related Art

In recognition processing by a stereo camera, there is known a technology to obtain three-dimensional information of a road surface and an object from a parallax image generated by parallax calculation, and to warn a vehicle equipped with the camera that there is a possibility of an accident. Patent Document 1 discloses a technology to extract a straight line by using a parallax image obtained from a stereo camera, and to determine that a low position exists when two straight lines are extracted.
Patent Document 1: Japanese Unexamined Patent Application Publication No. 2020-56717

### SUMMARY OF THE INVENTION

According to one aspect of the present invention, there is provided a step position detection apparatus including a processor; and a memory that includes instructions, which when executed, cause the processor to execute: acquiring, by an imaging device, a condition including at least a road surface around a work machine, as point group information; estimating an area where unevenness of the road surface does not exceed a predetermined height, as a flat road based on the acquired point group information including height information; and estimating an extended part of the road surface hidden by a step, among a first flat road where the work machine exists and a second flat road located at a lower position than the first flat road included in the estimated flat road.

### BRIEF DESCRIPTION OF THE DRAWINGS

FIG. 1 is an overall diagram of a work machine including a step position detection apparatus according to an embodiment of the present invention;

FIG. 2 is a hardware configuration diagram of a step position detection apparatus according to an embodiment of the present invention;

FIG. 3 is a functional block diagram of a step position detection apparatus according to an embodiment of the present invention;

FIG. 4 is a flow diagram of a process performed by a step position detection apparatus according to an embodiment of the present invention;

FIG. 5 is a diagram for explaining the road surface estimation process using the angle at which the point group information acquisition unit is attached to the work machine;

FIGS. 6A to 6C are diagrams illustrating an example of a two-dimensional map created based on the acquired point group information and a screen divided by a predetermined grid size in the step position detection apparatus according to an embodiment of the present invention;

FIG. 7 is a diagram illustrating an example of the relationship between the real distance and the real height corresponding to a position of a flat road in the real space in the step position detection apparatus according to an embodiment of the present invention;

FIG. 8 is a flow diagram of the road surface estimation process in the step position detection apparatus according to an embodiment of the present invention;

FIGS. 9A and 9B are diagrams illustrating an example of a step boundary surface for each grid space in the step position detection according to an embodiment of the present invention;

FIG. 10 is a flow diagram of the step shape determination process in the step position detection apparatus according to an embodiment of the present invention;

FIG. 11 is a flow diagram of the extended road surface estimation process in the step position detection apparatus according to an embodiment of the present invention;

FIG. 12 is a flow diagram of the step detection process in the step position detection apparatus according to an embodiment of the present invention; and

FIGS. 13A and 13B are conceptual diagrams for explaining an example of detecting a step position in a step position detection apparatus according to an embodiment of the present invention.

### DESCRIPTION OF THE EMBODIMENTS

In the technology disclosed in Patent Document 1, it is difficult to accurately detect a low position by using a parallax image obtained from a camera when the shape of the low position changes or there is a slope with a large slope angle. A problem to be addressed by an embodiment

of the present invention is to accurately detect a low position.

An embodiment of the invention will be described below with reference to the drawings. In each of the drawings, the same components are denoted by the same reference numerals, and duplicate descriptions may be omitted.

### History of the Investigation Until Conceiving a Step Position Detection Apparatus 1 According to the Embodiment

When a vehicle travels, it is necessary to determine whether there are risk factors by identifying the surrounding road surface state. Parallax information included in a parallax image is used as a method for estimating the road surface shape. There is a known method for applying this method to determine whether a step exists based on the unevenness of the road surface as indicated in Patent Document 1.

However, by the step detection using parallax information, it is possible to detect the step when the step is located in front of the stereo camera and at a short distance from the stereo camera. However, the step detection using parallax information cannot be used for a road surface where the shape of the low position changes depending on the orientation of the camera with respect to the low position, and a road surface where the slope angle is large.

Further, a boundary might not be detected on the road surface where a low position exists locally or when the distance from the stereo camera to the step is long. This is because the road surface under a step cannot be observed due to occlusion, and it is difficult to actually determine whether the height of the road surface changes rapidly from the boundary such as the step.

In a method of estimating the road surface by using a two-dimensional map on the assumption that the positional relationship between the step and the stereo camera is optional, for example, when there is a step on the side of the road surface, as the road surface information captured by the stereo camera, two road surfaces are observed, that is, one above the step and the other below the step. Therefore, the boundary cannot be detected by a method assuming a single road surface.

In the case of a road surface with a step provided obliquely, the distance to the step varies according to the real lateral position, and the boundary cannot be detected because the real lateral position is not a uniform step.

Therefore, a step position detection apparatus 1 according to the following embodiment which can solve such a problem has been found.

### Embodiment

### Configuration of the Step Position Detection Apparatus 1

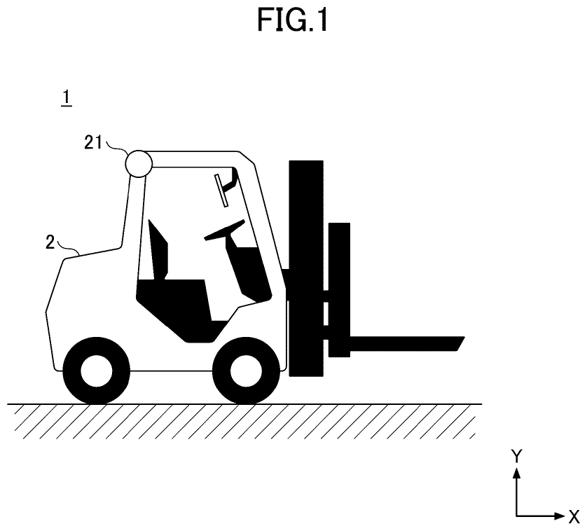

FIG. 1 is an overall diagram of a work machine 2 including the step position detection apparatus 1 according to an embodiment of the present invention. The work machine 2 is a forklift in the illustrated example, but it is not limited to this, and other work machines 2 such as wheel loaders and dump trucks may be used. In the following description, it is assumed that the step position detection apparatus 1 is attached to the work machine 2, but it may be installed at a different position without being attached to the work machine 2.

The work machine 2 is assumed to be forward in the X direction. A point group information acquisition unit 21 is attached to the work machine 2. The point group information acquisition unit 21 may be an imaging means such as a stereo camera. The point group information acquisition unit 21 is attached to the rear side (−X direction side) of the work machine 2. Note that the Y direction in the figure is the height direction.

The point group information acquisition unit 21 acquires the condition including at least the road surface around the work machine 2 as the point group information. The area around the work machine 2 may be the area behind the work machine 2. Based on the point group information including the height information acquired by the point group information acquisition unit 21, the step position detection apparatus 1 can detect a first flat road where the work machine 2 exists and a second flat road located at a lower position than the first flat road.

The step position detection apparatus 1 may be provided with a reporting means for reporting a message when the step between the first flat road and the second flat road is a predetermined value or more. Preferably, the reporting means is a means that can warn the driver of the work machine 2 based on the existence of a step and the position information of the step. Therefore, the reporting means includes, but is not limited to, for example, a pad lamp and an alarm unit.

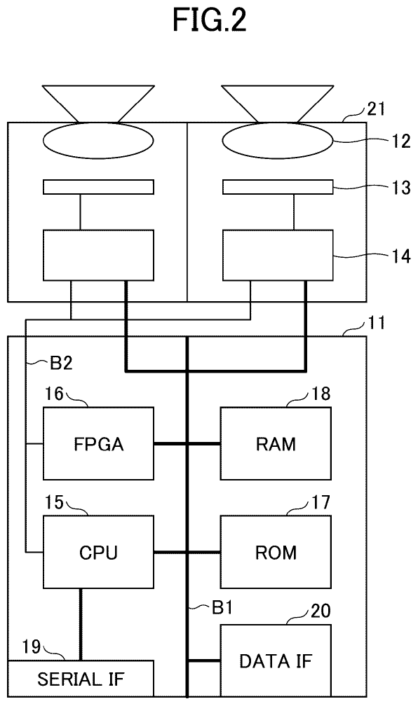

FIG. 2 is a hardware configuration diagram

of the step position detection apparatus 1 according to an embodiment of the present invention. As illustrated, the step position detection apparatus 1 includes the point group information acquisition unit 21 and an image processing substrate 11.

The point group information acquisition unit 21 may have two imaging devices arranged in parallel. The imaging devices may be, for example, a stereo camera. The point group information acquisition unit 21 includes a lens 12, an image sensor 13, and an image sensor controller 14. The point group information acquisition unit 21 is connected to the image processing substrate 11 by a data bus B1 and a serial bus B2.

The image sensor controller 14 performs exposure control of the image sensor 13, image read control, communication with external circuits, and transmission of image data. Luminance image data captured by the point group information acquisition unit 21 is transferred from the image sensor 13 to the RAM 18 of the image processing substrate 11 via the data bus B1. The serial bus B2 transmits and receives the sensor exposure control value change, image read parameter change, and various kinds of setting data, from the CPU (Central Processing Unit) 15 and the FPGA (Field-Programmable Gate Array) 16.

The image processing substrate 11 includes a CPU 15, an FPGA 16, a ROM (Read Only Memory) 17, a RAM (Random Access Memory) 18, a serial IF (Interface) 19, a data IF 20, a data bus B1, and a serial bus B2. The CPU 15 controls the overall operation of the image processing substrate 11, performs image processing, and performs image recognition processing.

The FPGA 16 performs processing that requires real-time performance on the luminance image data stored in the RAM 18, such as gamma correction and distortion correction for parallelizing left and right images, performs parallax calculation by block matching to generate parallax images, and writes the parallax images back to the RAM 18.

The CPU 15 loads a program for executing road surface shape detection and object detection from the ROM 17. The CPU 15 executes various processes by using the luminance image and parallax image stored in the RAM 18 as inputs, and outputs detection data from the serial IF 19 or the data IF 20 to the outside.

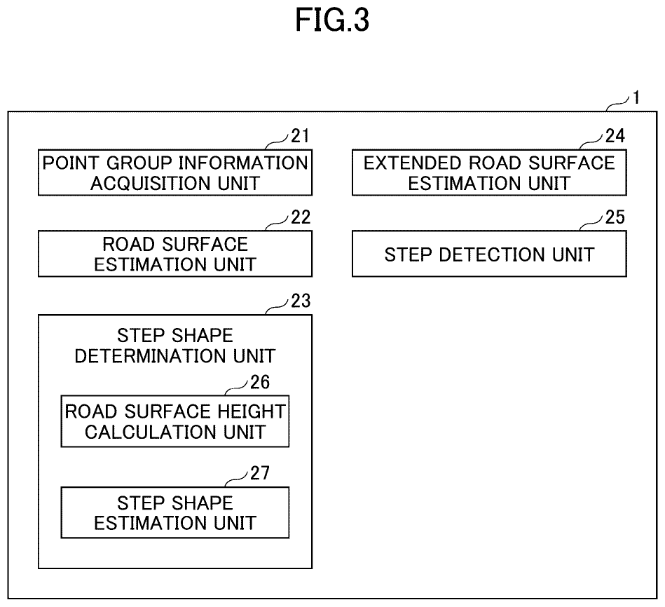

FIG. 3 is a functional block diagram of the step position detection apparatus 1 according to an embodiment of the present invention. As illustrated, the step position detection apparatus 1 includes a point group information acquisition unit 21, a road surface estimation unit 22, a step shape determination unit 23, an extended road surface estimation unit 24, and a step detection unit 25. The step shape determination unit 23 includes a road surface height calculation unit 26 and a step shape estimation unit 27. The functions of each of these units may be included in the CPU 15 or the FPGA 16, or the image sensor controller 14.

The point group information acquisition unit 21 acquires a condition including at least a road surface around the work machine 2 as point group information.

The road surface estimation unit 22 estimates an area where the unevenness of the road surface does not exceed a predetermined height as a flat road, based on the point group information including the height information acquired by the point group information acquisition unit 21. The road surface estimation unit 22 creates a two-dimensional map based on the point group information, and estimates the road surface by dividing the two-dimensional map by a predetermined grid space size. The road surface estimation unit 22 estimates the slope of the second flat road with respect to the first flat road.

The step shape determination unit 23 detects the boundary between the first flat road where the work machine 2 exists estimated by the road surface estimation unit 22 and the second flat road located at a lower position than the first flat road, and estimates the shape of the step from the position of the boundary and the angular state of the boundary.

The road surface height calculation unit 26 calculates the road surface height by searching in the two directions of the right and left directions in the real lateral position of the point group information based on the result estimated by the road surface estimation unit 22. The road surface height calculation unit 26 calculates the difference between the road surface height of the first flat road and the road surface height of the second flat road, with the boundary as the height.

The step shape estimation unit 27 estimates the shape of the step line based on the calculated road surface height. The step shape estimation unit 27 estimates the shape of the boundary at the step, based on the position of the boundary between the first flat road and the second flat road.

The extended road surface estimation unit 24 estimates the extended part of the road surface hidden by the step, among the first flat road where the work machine 2 exists estimated by the road surface estimation unit 22 and the second flat road at a lower position than the first flat road. The extended road surface estimation unit 24 estimates the step between the first flat road and the second flat road by extending the second flat road in the direction in which the road surface hidden by the step is extended.

The extended road surface estimation unit 24 estimates the extended part of the road surface hidden by the step based on the mounting angle of the point group information acquisition unit 21 to the work machine 2. In the following, the mounting angle of the point group information acquisition unit 21 to the work machine 2 is referred to as a camera mounting angle, and information including the camera mounting angle is referred to as camera mounting angle information.

The step detection unit 25 performs processing for detecting the step based on the estimation result of the extended part of the road surface hidden by the step, performed by the extended road surface estimation unit 24.

### Flow of the Entire Process

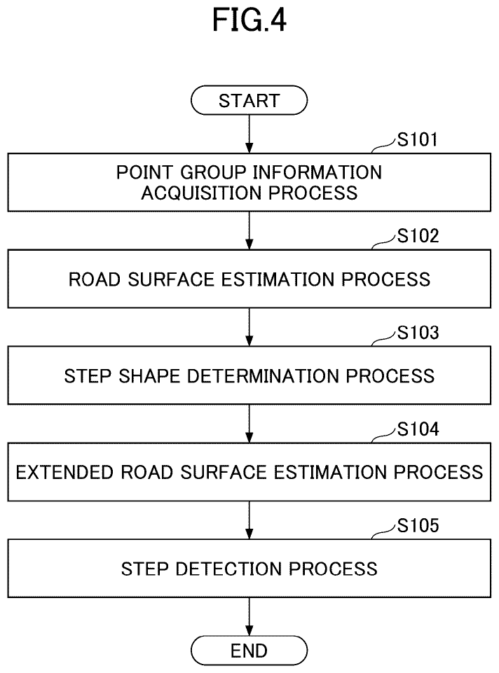

FIG. 4 is a flow diagram of the process performed by the step position detection apparatus 1 according to an embodiment of the present invention. First, in the point group information acquisition process in step S101, the point group information acquisition unit 21 acquires a condition including at least a road surface around the work machine 2 captured by two imaging devices arranged in parallel, performs parallax calculation, and generates a parallax image as the point group information.

Next, in the road surface estimation process in step S102, the road surface estimation unit 22 creates a two-dimensional map based on the point group information, and divides the two-dimensional map by a predetermined grid space size. Then, the road surface estimation unit 22 estimates the road surface state based on the height information in each grid space. In the road surface estimation process, the slope of the second flat road with respect to the first flat road is estimated.

In the road surface state estimation process, the road surface state assuming a flat road is calculated based on the camera mounting angle information which is the mounting angle of the imaging device to the work machine 2. With respect to the calculated road surface of the flat road, the road surface appearing on the parallax image is projected onto the two-dimensional map.

Next, in step S103, in the step shape determination process, the step shape determination unit 23 extracts the position assumed to be a step based on the road surface height of each grid space, and estimates the shape of the step line based on the extraction result.

The step shape estimation unit 27 estimates the shape of the step line based on the calculated road surface height. The step shape estimation unit 27 estimates the shape of the boundary at the step, based on the position of the boundary between the first flat road and the second flat road and the angular state of the boundary.

Next, in step S104, in the extended road

surface estimation process, the extended road surface estimation unit 24 estimates the extended part of the road surface hidden by the step among the first flat road where the work machine 2 exists and the second flat road located at a lower position than the first flat road estimated by the road surface estimation unit 22. The extended road surface estimation unit 24 estimates the step between the first flat road and the second flat road by extending the second flat road in the direction in which the road surface hidden by the step is extended. The extended road surface estimation unit 24 estimates the extended part of the road surface hidden by the step based on the camera mounting angle information.

In the extended road surface estimation process, the road surface in the traveling direction is determined based on the estimation result of the step shape. Therefore, the road surface hidden by the step can be estimated by extending the road surface under the step in the extended direction.

Finally, in the step detection process, the step detection unit 25 performs a process of detecting the step based on the estimation result of the extended part of the road surface hidden by the step performed by the extended road surface estimation unit 24. More specifically, the step detection unit 25 estimates the road surface hidden by the step, and calculates the position of the step again to detect the step position.

Details of each process performed by the step position detection apparatus 1 will be described below.

### Point Group Information Acquisition Process

The point group information acquisition unit 21 acquires the point group information by parallax calculation. In the parallax calculation, the position in the depth direction as seen from the user can be adjusted by adjusting the parallax caused by the positional relationship between the left and right imaging devices. Then, in order to detect the parallax, a local image matching process is performed.

The matching method may be, for example, a block matching method. The block matching method is a method in which, with respect to a selected area in one image, an area of high similarity is searched from another image, and the difference in the position with the area of high similarity is regarded as the parallax.

In the image matching process, the parallax is detected in units of pixels. Therefore, it is necessary to estimate the parallax of the sub-pixel level, which is less than one pixel. For this estimation, the conformal linear method and the quadratic curve method are used. Such a method is applicable not only to imaging devices, but also to sensing devices such as LiDAR and ToF sensors, for which the distance to the irradiation position is required.

### Road Surface Estimation Process

FIG. 5 is a diagram for explaining the road surface estimation process using the camera mounting angle information. FIG. 5 illustrates the relationship between the lens 12 and the image sensor 13 in the imaging device of the point group information acquisition unit 21. In the figure, θ indicates the camera mounting angle, h indicates the camera mounting height, and f indicates the focal distance of the lens 12. The image sensor 13 is arranged at a position away from the lens 12 by the focal distance f.

The road surface estimation unit 22 calculates the slope of a flat road based on information such as the camera mounting height h and the camera mounting angle θ. A flat road is defined as a road surface with a slope of 0 degrees. If the camera mounting angle θ is not 0°, the distance between the point group information acquisition unit 21 and the road surface changes.

Therefore, the camera height is corrected by an amount corresponding to the camera mounting angle such that the point group information acquisition unit 21 is parallel to the flat road, based on the camera mounting angle information. By this correction, the image captured by the imaging device and imaged to the image sensor 13 moves to the area R in the figure. Therefore, the flat road is estimated without affecting the camera mounting angle θ.

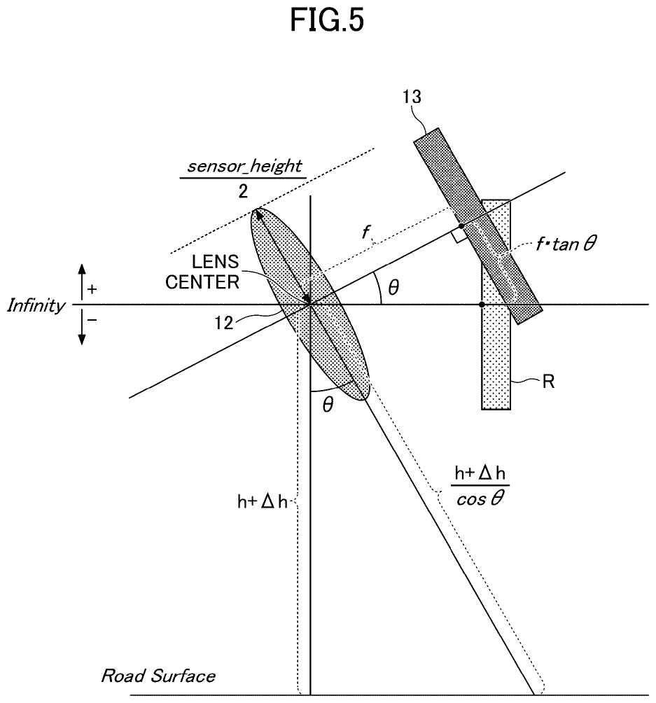

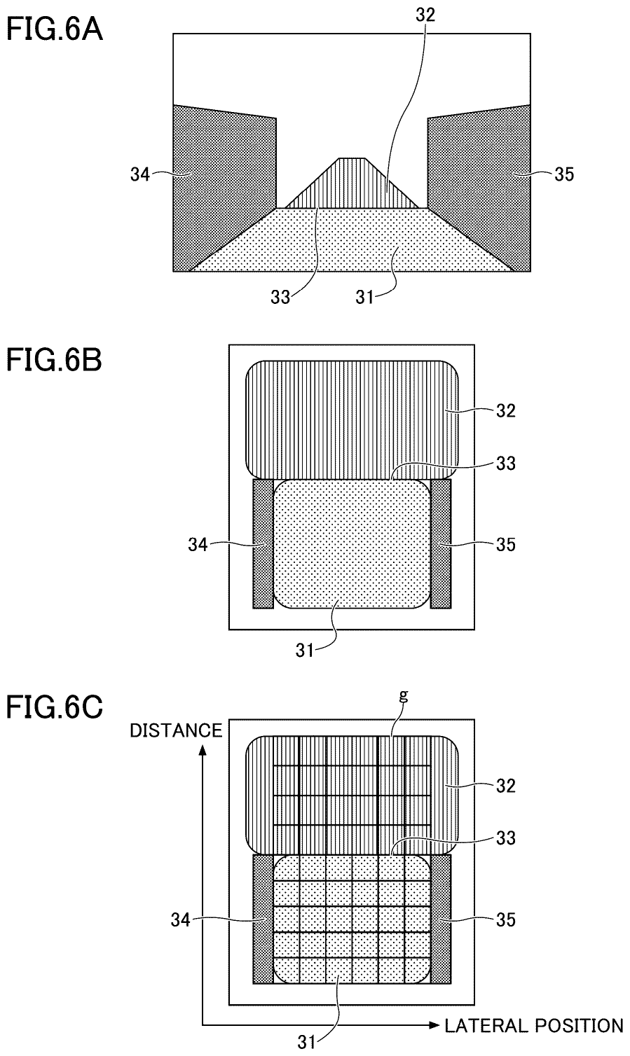

FIGS. 6A to 6C are diagrams illustrating an example of a two-dimensional map created based on the acquired point group information and a two-dimensional map divided by a predetermined grid space size in the step position detection apparatus 1 according to an embodiment of the present invention. FIG. 6A illustrates a parallax image representing the acquired point group information, FIG. 6B illustrates a two-dimensional map created based on FIG. 6A, and FIG. 6C illustrates a two-dimensional map divided by a predetermined grid space size.

The input image representing the point group information illustrated in FIG. 6A includes the first flat road 31 where the work machine 2 exists and the second flat road 32 located at a lower position than the first flat road 31. A step 33 as a boundary exists between the first flat road and the second flat road. Further, walls 34 and 35 are included on the left and right sides of the first flat road 31.

As illustrated in FIGS. 6B and 6C, the two-dimensional map is a figure in which the distance is projected on the vertical axis and the real lateral position is projected on the horizontal axis. As illustrated in FIG. 6C, the two-dimensional map is divided by a predetermined grid space size. In FIG. 6C, g indicates a grid.

The two-dimensional map is created by taking the real distance as the vertical axis and projecting the corresponding real height at the position in the real space. The standard of the projected height is the height of the flat road observed by the point group information acquisition unit 21. When the height of the flat road is used as the standard, the height of an object such as a road surface observed by the point group information acquisition unit 21 is projected on the two-dimensional map.

As the height at the time of projection, information including the road surface height existing around the point group information acquisition unit 21 can be identified by projecting the minimum height of each area observed by the point group information acquisition unit 21 on the two-dimensional map.

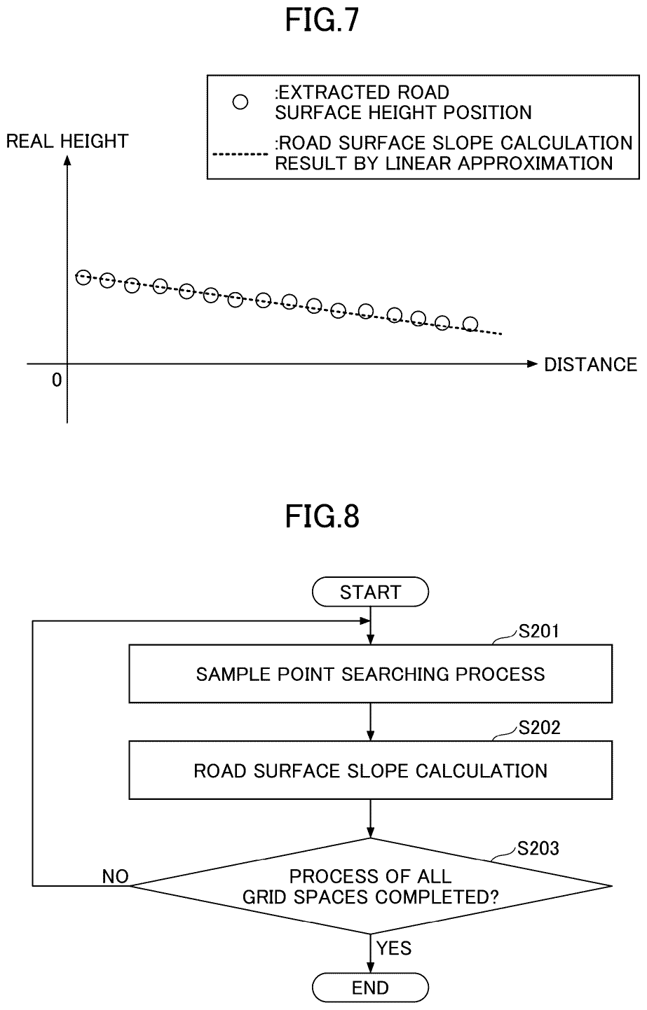

FIG. 7 is a diagram illustrating an example of the relationship between the real distance and the real height corresponding to a position in the real space of a flat road in the step position detection apparatus 1 according to an embodiment of the present invention. The vertical axis indicates the real height at the extracted position, and the horizontal axis indicates the distance from the work machine 2. The circles in the figure indicate the real height at each distance, and the dashed line indicates the result of calculating the road surface slope by linear approximation.

The road surface estimation unit 22 takes a two-dimensional map created based on the point group information as an input, and can estimate the road surface slope at each grid space g into which the map is divided. Continuity of the road surface height at each grid space g is obtained based on the data as a sample point extracted from the height information projected on each grid space g in the two-dimensional map. Therefore, the road surface estimation unit 22 can estimate the road surface slope based on the result of the road surface height by the linear approximation.

Here, when x is the distance from the work machine 2, the road surface slope is expressed by the following equation (1). In equation (1), a and b are the slope and the intercept, respectively, and are represented by equations (2) and (3), respectively. n is the number of grid spaces g into which the map is divided.

$$[ Formula 1 ]$$

$$f ( x ) = a x + b \qquad ( 1 )$$

$$a = \frac{n {\sum }_{k = 1}^{n} {x}_{k} {y}_{k} - {\sum }_{k = 1}^{n} {x}_{k} {\sum }_{k = 1}^{n} {y}_{k}}{n {\sum }_{k = 1}^{n} {x}_{k}^{2} - {( {\sum }_{k = 1}^{n} {x}_{k} )}^{2}} \qquad ( 2 )$$

$$b = \frac{{\sum }_{k = 1}^{n} {x}_{k}^{2} {\sum }_{k = 1}^{n} {y}_{k} - {\sum }_{k = 1}^{n} {x}_{k} {y}_{k} {\sum }_{k = 1}^{n} {x}_{k}}{n {\sum }_{k = 1}^{n} {x}_{k}^{2} - {( {\sum }_{k = 1}^{n} {x}_{k} )}^{2}} \qquad ( 3 )$$

FIG. 8 is a flow diagram of road surface estimation processing in the step position detection apparatus 1 according to an embodiment of the present invention. The road surface estimation unit 22 searches data to be sample points extracted from the height information projected on each grid space g in the two-dimensional map (step S201). The road surface estimation unit 22 calculates the slope of the road surface in each grid space g based on the height information at the sample point (step S202).

The road surface estimation unit 22 continues the process if the road surface slope calculation processing has not been completed in all grid spaces g included in the two-dimensional map (NO in step S203), and completes the process if the road surface slope calculation processing has been completed in all grid spaces g (YES in step S203).

### Step Shape Determination Process

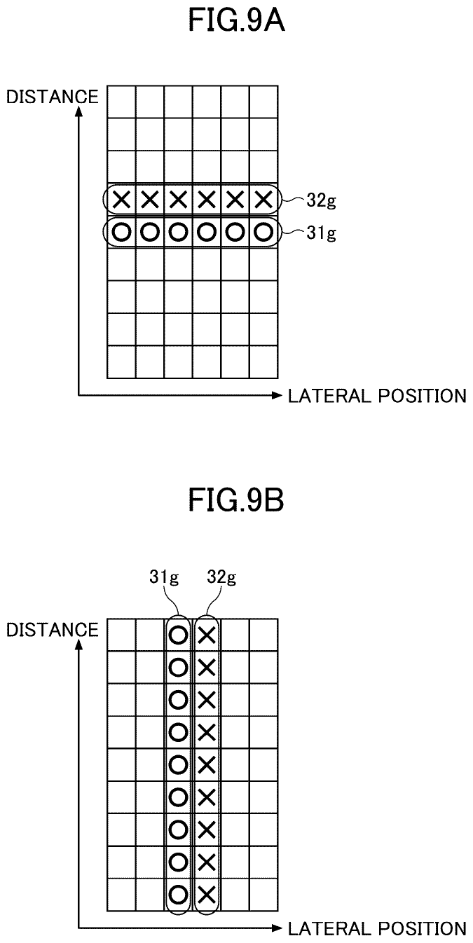

FIGS. 9A and 9B are diagrams illustrating an example of a step boundary surface for each grid space g in step position detection according to an embodiment of the present invention. FIG. 9A illustrates an example of a step 33 in the lateral direction, and FIG. 9B illustrates an example of the step 33 in the traveling direction.

In the example of FIG. 9A, the side below the step 33 is the first flat road 31 where the work machine 2 exists, and the side above the step 33 is the second flat road 32 which is located lower than the first flat road 31. The road surface grid spaces 31g above the step are the grid spaces g contacting the boundary on the side of the first flat road 31, and the road surface grid spaces 32g below the step are the grid spaces g contacting the boundary on the side of the second flat road 32.

In the example of FIG. 9B, the left side of the step 33 is the first flat road 31 where the work machine 2 exists, and the right side of the step 33 is the second flat road 32. The road surface grid spaces 31g above the step are the grid spaces g contacting the boundary on the side of the first flat road 31, and the road surface grid spaces 32g below the step are the grid spaces g contacting the boundary on the side of the second flat road 32.

The road surface height calculation unit 26 of the step shape determination unit 23 calculates the road surface height from the road surface slope information of each grid space g, and calculates the relative height between grid spaces g. If the relative height exceeds a predetermined height, the road surface height calculation unit 26 determines that there is a step at that position.

In each example illustrated in FIGS. 9A and 9B, the height of the road surface grid space 31g above the step is higher relative to the road surface grid space 32g below the step by greater than or equal to a predetermined height. Therefore, the road surface height calculation unit 26 determines that there is a boundary that is a step between the road surface grid space 31g above the step and the road surface grid space 32g below the step.

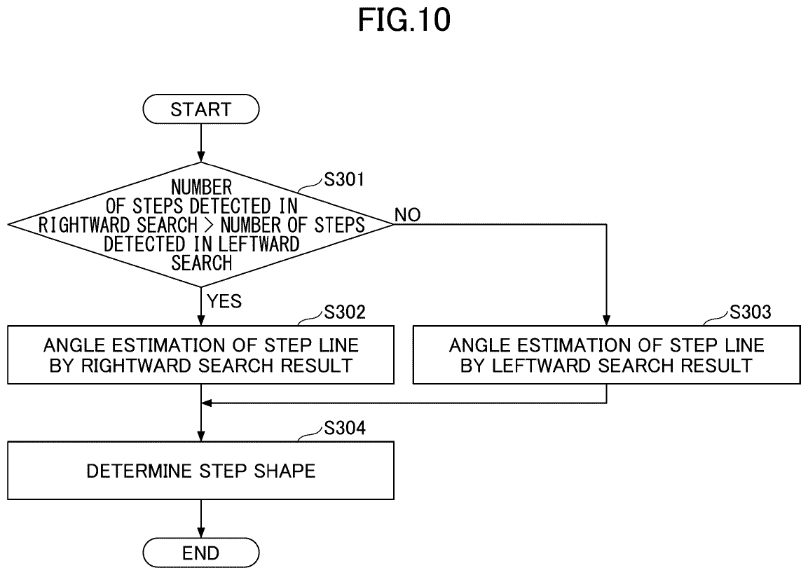

FIG. 10 is a flow diagram of step shape determination processing in the step position detection apparatus 1 according to an embodiment of the present invention.

The step shape determination unit 23 performs a search twice, that is, a search from left to right (hereinafter referred to as rightward search) and a search from right to left (hereinafter referred to as leftward search), with respect to a two-dimensional map divided by a predetermined grid space size, and records the number of times a step is determined in each search.

If the number of steps detected in the rightward search is greater than the number of steps detected in the leftward search (YES in step S301), the step shape determination unit 23 estimates the angle value of the detected step line by using the result of the rightward search (step S302). If the number of steps detected in the rightward search is less than or equal to the number of steps detected in the leftward search (NO in step S301), the step shape determination unit 23 estimates the angle value of the detected step line by using the result of the leftward search (step S303). Thereafter, the step shape determination unit 23 determines the step shape (step S304), and the flow of the step shape determination processing ends.

The road surface height calculation unit 26 calculates the road surface height by searching in the right and left directions at the real lateral position of the point group information. The step shape estimation unit 27 estimates the shape of the step line based on the calculated road surface height. The step shape estimation unit 27 can also estimate the distance to the step at each lateral position which cannot be expressed by the grid space g by estimating the angle value of the step line.

Further, because the step shape determination unit 23 calculates the road surface height by searching in the right and left directions, it is possible to determine which left or right side the road surface below the step exists, when the road surface above the step exists on the left side and the road surface below the step exists on the right side, or when the road surface below the step exists on the left side and the road surface above the step exists on the right side.

### Extended Road Surface Estimation Process

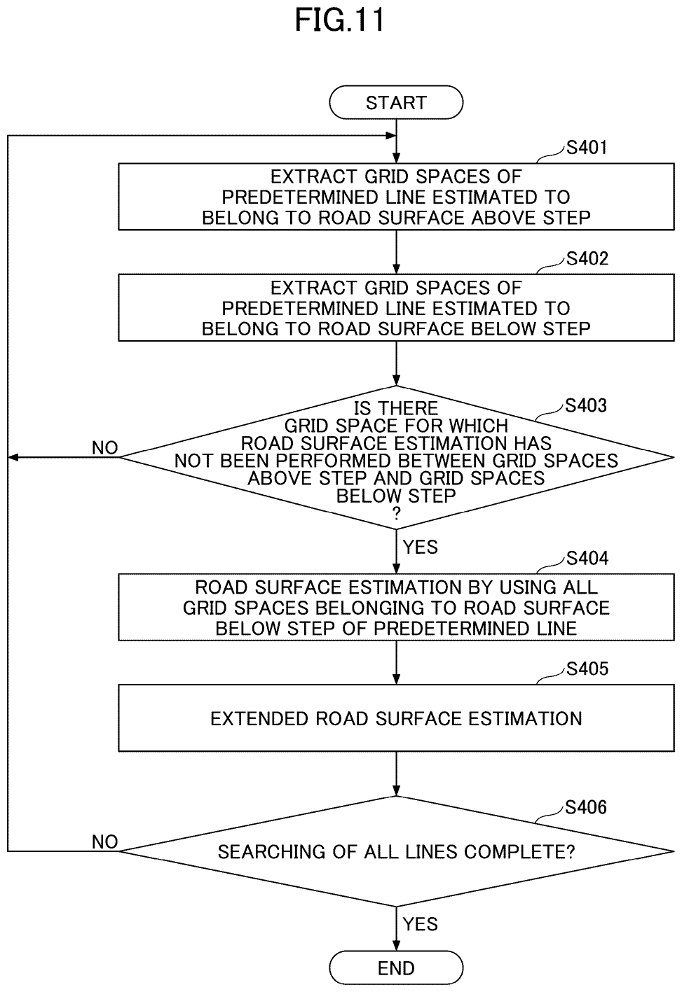

FIG. 11 is a flow diagram of the extended road surface estimation process in the step position detection apparatus 1 according to an embodiment of the present invention.

The extended road surface estimation unit 24 extracts the grid spaces g of a predetermined line estimated by the step shape determination unit 23 in the first flat road 31 (step S401). Next, the extended road surface estimation unit 24 extracts the grid spaces g of a predetermined line determined by the step shape determination unit 23 in the second flat road 32 located lower than the first flat road 31 (step S402).

If there is no grid space g for which the road surface estimation process has not been performed between the grid spaces g of the first flat road 31 and the grid spaces g of the second flat road 32 (NO in step S403), the process returns to step S401. If there is a grid space g for which the road surface estimation process has not been performed between the grid spaces g of the first flat road 31 and the grid spaces g of the second flat road 32 (YES in step S403), the extended road surface estimation unit 24 performs the road surface estimation process for all the grid spaces g of the second flat road 32 (step S404). On the other hand, if there is no grid space g for which the road surface estimation process has not been performed between the grid spaces g of the first flat road 31 and the grid spaces g of the second flat road 32 (NO in step S403), the extended road surface estimation unit 24 performs the process of step S401. The extended road surface estimation unit 24 extracts the grid spaces g of the predetermined line estimated by the step shape determination unit 23 in the first flat road 31 (step S401).

After the processing in step S404, the extended road surface estimation unit 24 estimates the extended part of the road surface hidden by the step 33 (step S405). When the search for the grid spaces g of all the lines is completed (step S406), the extended road surface estimation processing is completed. On the other hand, if the search for all the lines is not completed (NO in step S406), the extended road surface estimation unit 24 performs the processing in step S401. The extended road surface estimation unit 24 extracts the grid spaces g of the predetermined line estimated by the step shape determination unit 23 on the first flat road 31 (step S401).

In the extended road surface estimation processing, the road surface under the step which cannot be observed due to the step 33, is determined in the road surface estimation result in the traveling direction. When the corresponding road surface is determined, the extended road surface estimation unit 24 obtains the continuity of the slope information of the second flat road 32 already obtained by the road surface estimation processing.

As the method, the slope information of the road surface determined to belong to the second flat road 32 is averaged. In the extended road surface estimation process, the road surface can be estimated with respect to the road surface hidden by the step 33 by using the averaged slope information, from the farthest grid space g to the nearest grid space g among the corresponding line in the second flat road 32.

### Step Detection Process

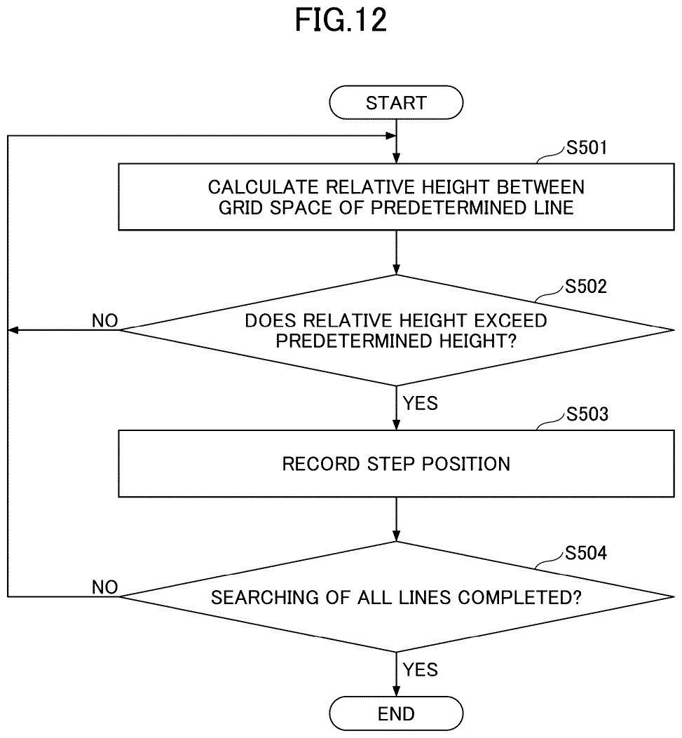

FIG. 12 is a flow diagram of the step detection process in the step position detection apparatus 1 according to an embodiment of the present invention. The step detection unit 25 performs a process for detecting the step 33 based on the estimation result of the extended part of the road surface hidden by the step 33 performed by the extended road surface estimation unit 24.

The step detection unit 25 calculates the relative height between the grid spaces g of the predetermined line (step S501). If the calculated relative height exceeds the predetermined height (YES in step S502), the step detection unit 25 records the position as the step 33 (step S503). On the other hand, if the calculated relative height exceeds the predetermined height (NO in step S502), the step detection unit 25 performs the process of step S501 for calculating the relative height between the grid spaces g of the predetermined line (step S501). Then, after the recording in step S503, the step detection unit 25 completes the step detection process if the search in all lines is completed (YES in step S504). On the other hand, if the search in all lines is not completed (NO in step S504), the step detection unit 25 performs the process of step S501 to calculate the relative height between the grid spaces g of a predetermined line (step S501).

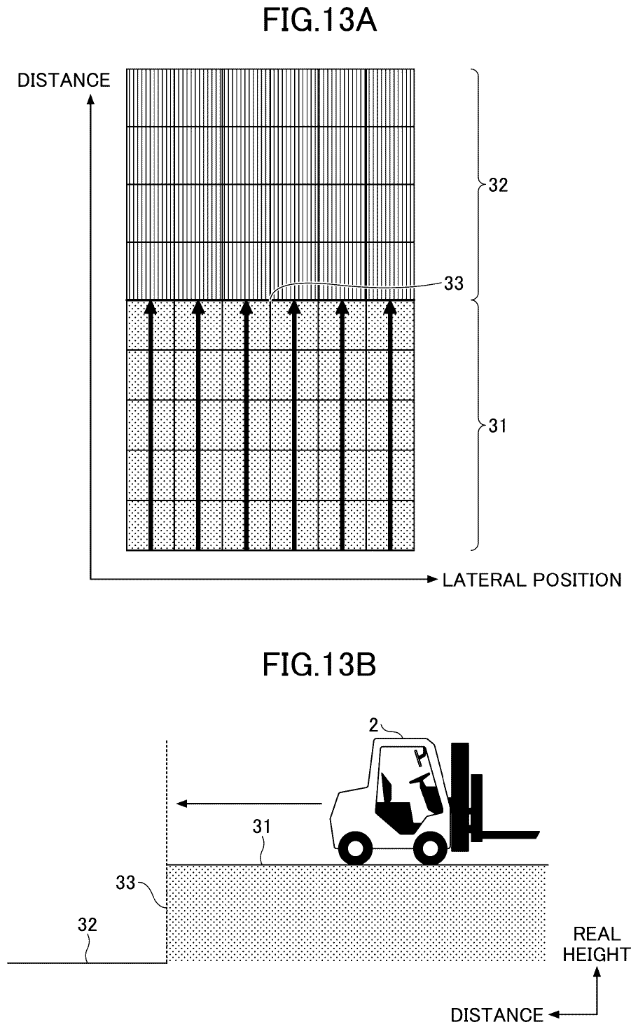

FIGS. 13A and 13B are conceptual diagrams for explaining an example of detecting the step position in the step position detection apparatus 1 according to an embodiment of the present invention. FIG. 13A illustrates the position of the step 33 on the two-dimensional map, and FIG. 13B illustrates the positional relationship between the work machine 2 and the step 33.

When the work machine 2 is advancing in the direction of the arrow in the two-dimensional map of FIG. 13A and in the direction of the arrow in FIG. 13B, the step position detection apparatus 1 can send a report to the driver of the work machine 2 by outputting the distance from the work machine 2 to the step 33 and the real lateral position. The reporting means can warn the driver of the work machine 2 based on the existence of the step 33 and the position information of the step 33.

### Function Effect

According to the step position detection apparatus 1 according to the present embodiment, road surface information is acquired not as two-dimensional information of distance and height, but as three-dimensional information of a lateral position, a distance, and a height. Therefore, the step 33 can be stably detected regardless of the positional relationship between the imaging device as the point group information acquisition unit 21 and the step 33. Further, within the second flat road 32 located at a lower position than the first flat road 31, the extended part of the road surface hidden by the step 33 is estimated.

Therefore, according to the step position detection apparatus 1 according to the present embodiment, a low position can be accurately detected not only when the shape of the low position changes or there is a slope with a large slope angle, but also when there is an extended part of the road surface hidden by the step 33.

Although the above-described embodiments have been described, the present invention is not limited to the above-described embodiments, and various modifications and improvements can be made within the scope of the present invention.

Each of the functions of the above-described embodiment can be implemented by one or more processing circuits. The term “processing circuit” as used herein includes a processor programmed to execute each function by software, such as a processor implemented by an electronic circuit, and devices such as an ASIC (Application Specific Integrated Circuit), DSP (Digital Signal Processor), FPGA (Field Programmable Gate Array), or conventional circuit modules designed to execute each of the above-described functions.

Embodiments of the present invention are, for example, as follows.
<1> A step position detection apparatus including: a point group information acquisition unit which acquires a condition including at least a road surface around a work machine, as point group
a road surface estimation unit which estimates an area where unevenness of the road surface does not exceed a predetermined height, as a flat road based on the point group information including height information acquired by the point group information acquisition unit; and
an extended road surface estimation unit which estimates an extended part of the road surface hidden by a step, among a first flat road where the work machine exists and a second flat road located at a lower position than the first flat road included in the flat road estimated by the road surface estimation unit.
<2> The step position detection apparatus according to <1>, wherein the road surface estimation unit creates a two-dimensional map based on the point group information, and estimating the road surface by dividing the two-dimensional map by a predetermined grid space size.
<3> The step position detection apparatus according to <1> or <2>, wherein the road surface estimation unit estimates a slope of the second flat road with respect to the first flat road. <4> The step position detection apparatus according to any one of <1> to <3>, wherein the extended road surface estimation unit estimates the step with respect to the first flat road by extending the second flat road, in a direction in which the road surface hidden by the step extends.
<5> The step position detection apparatus according to any one of <1> to <4>, wherein the extended road surface estimation unit estimates the extended part of the road surface hidden by the step based on a mounting angle of the point group information acquisition unit with respect to the work machine.
<6> The step position detection apparatus according to any one of <1> to <5>, wherein the point group information acquisition unit includes a stereo camera.
<7> The step position detection apparatus according to any one of <1> to <5>, further including:
a reporting unit which reports a message when the step between the first flat road and the second flat road is greater than or equal to a predetermined value.
<8> A step position detection apparatus including:
a point group information acquisition unit which acquires a condition including at least a road surface around a work machine, as point group information;
a road surface estimation unit which estimates an area where unevenness of the road surface does not exceed a predetermined height, as a flat road based on the point group information including height information acquired by the point group information acquisition unit; and
a step shape determination unit which detects a boundary between a first flat road where the work machine exists and a second flat road located at a lower position than the first flat road included in the flat road estimated by the road surface estimation unit, and estimates a shape of a step from a position of the boundary and an angular state of the boundary.
<9> The step position detection apparatus according to <8>, wherein
the step shape determination unit includes:
a road surface height calculation unit which calculates a road surface height by searching the point group information in right and left directions at a real lateral position, based on a result of the estimating by the road surface estimation unit; and
a step shape estimation unit which estimates the shape of a line of the step based on the calculated road surface height.
<10> The step position detection apparatus according to <9>, wherein the road surface height calculation unit calculates a difference in the road surface height between the first flat road and the second flat road, by using the boundary as a height.
<11> The step position detection apparatus according to <9> or <10>, wherein the step shape determination unit estimates a shape of the boundary at the step, based on a position of the boundary between the first flat road and the second flat road.

According to one embodiment of the present invention, the step position detection apparatus can accurately detect a low position.

What is claimed is:

1. A step position detection apparatus comprising:
a processor; and
a memory that includes instructions, which when executed, cause the processor to execute:
acquiring, by an imaging device, a condition including at least a road surface around a work machine, as point group information;
estimating an area where unevenness of the road surface does not exceed a predetermined height, as a flat road based on the acquired point group information including height information; and
estimating an extended part of the road surface hidden by a step, among a first flat road where the work machine exists and a second flat road located at a lower position than the first flat road included in the estimated flat road.

2. The step position detection apparatus according to claim 1, wherein the instructions, which when executed, cause the processor to execute:
creating a two-dimensional map based on the point group information, and estimating the road surface by dividing the two-dimensional map by a predetermined grid space size.

3. The step position detection apparatus according to claim 1, wherein the instructions, which when executed, cause the processor to execute:
estimating a slope of the second flat road with respect to the first flat road.

4. The step position detection apparatus according to claim 1, wherein the instructions, which when executed, cause the processor to execute:
estimating the step with respect to the first flat road by extending the second flat road, in a direction in which the road surface hidden by the step extends.

5. The step position detection apparatus according to claim 1, wherein the instructions, which when executed, cause the processor to execute:
estimating the extended part of the road surface hidden by the step based on a mounting angle of the imaging device with respect to the work machine.

6. The step position detection apparatus according to claim 1, wherein the imaging device includes a stereo camera.

7. The step position detection apparatus according to claim 1, wherein the instructions, which when executed, cause the processor to execute:
reporting a message when the step between the first flat road and the second flat road is greater than or equal to a predetermined value.

8. A step position detection apparatus comprising:
a processor; and
a memory that includes instructions, which when executed, cause the processor to execute:
acquiring, by an imaging device, a condition including at least a road surface around a work machine, as point group information;
estimating an area where unevenness of the road surface does not exceed a predetermined height, as a flat road based on the acquired point group information including height information; and
detecting a boundary between a first flat road where the work machine exists and a second flat road located at a lower position than the first flat road included in the estimated flat road, and estimating a shape of a step from a position of the boundary and an angular state of the boundary.

9. The step position detection apparatus according to claim 8, wherein the instructions, which when executed, cause the processor to execute:
calculating a road surface height by searching the point group information in right and left directions at a real lateral position, based on a result of the estimating; and
estimating the shape of a line of the step based on the calculated road surface height.

10. The step position detection apparatus according to claim 9, wherein the calculating includes calculating a difference in the road surface height between the first flat road and the second flat road, by using the boundary as a height.

11. The step position detection apparatus according to claim 9, wherein the estimating of the shape includes estimating a shape of the boundary at the step, based on a position of the boundary between the first flat road and the second flat road.
